(19) United States
(12) Patent Application Publication
(10) Pub. No.: US 2007/0113671 A1
(43) Pub. Date: May 24, 2007

(54) METHOD OF CRACK GROWTH TESTING FOR THIN SAMPLES

(75) Inventors: C. Robert Samples, Akron, OH (US); Timothy W. Samples, Clinton, OH (US); Walter B. Samples, Akron, OH (US); Edward Wronkovich, Wooster, OH (US); Mark Centea, Wadsworth, OH (US); Blake Edward Matthies, Akron, OH (US)

Correspondence Address: HAHN LOESER & PARKS, LLP, One GOJO Plaza, Suite 300, AKRON, OH, 44311-1076, US

(73) Assignee: AKRON RUBBER DEVELOPMENT LABORATORY, INC., Akron, OH (US)

(21) Appl. No.: 11/558,517

(22) Filed: Nov. 10, 2006

Related U.S. Application Data
(60) Provisional application No. 60/735,665, filed on Nov. 10, 2005.

(51) Int. Cl. G01N 3/32

(52) U.S. Cl. 73/808

(57) ABSTRACT

A method of determining the crack growth life of a thin, polymeric material is provided. The method includes the steps of providing a sample of the thin, polymeric material having a predetermined length, width and thickness. A groove is then formed in the sample followed by the formation of a crack in the groove. The sample is then secured in a test apparatus that cycles the sample in a bending mode at a predetermined frequency. The crack length is measured in the sample after a predetermined number of cycles. The crack growth data is collected over a period of cycles to determine the crack growth life in the sample.

### CROSS-REFERENCE TO RELATED APPLICATION/INCORPORATION BY REFERENCE

The present application claims priority from U.S. provisional application Ser. No. 60/735,665, filed on Nov. 10, 2005. The disclosure of Ser. No. 60/735,665 is hereby incorporated by reference.

### BACKGROUND OF THE INVENTION

The major cause of radial tire failure is belt edge separation between the steel belts of the tire. The failure is typically initiated by “socketing” of the belt ends of the steel cord of the outer steel belt. This socketing results in cracks in the surrounding rubber which grow under continuous use of the tire. Once belt edge separations have initiated, they may grow circumferentially and laterally along the edge of the outer belt and develop into cracks between the outer and inner belts. The crack growth of the rubber progresses between the belts until failure occurs.

Many of the synthetic rubber compounds used in tires are extremely resistant to flexing-fatigue cracking. However, their crack resistance performance varies dramatically once an initial crack is generated, such as that caused by socketing. Different tests have been developed in order to predict and rank the susceptibility of different rubber compounds to crack growth. The most widely accepted test for estimating the ability of a rubber vulcanizate to resist crack growth when subjected to repeated bending strain or flexing, is commonly known as the DeMattia test method. The DeMattia test method is described in ASTM D430-1995 (re-approved 2000); method B, ASTM D813-1995 (re-approved 2000) and DIN 53 522.

The DeMattia test method, according to the ASTM standards, estimates a relative crack growth failure life. The test uses a test specimen that is six inches long, one inch wide, a quarter of an inch thick, and has a transverse groove or neck formed at the midpoint of the specimen. The test specimens are molded or cut to the proper dimensions, pierced at the bottom of the groove to initiate a crack, and then conditioned prior to testing. While the DeMattia test has generally been accepted in the industry, there are several drawbacks related to the size of test specimen and the associated test method. Two of the most critical design feature used by tire manufacturers to suppress the initiation and growth of belt-edge cracks is the “belt wedge,” a strip of rubber located between the two belts near the belt edges on each side of the tire, and the “belt skim” which is the rubber coating on the steel cords of the belts and therefore separates the two belts. With the DeMattia test, skim and wedge rubber compound candidates are molded as test specimens using a candidate material. The actual belt wedge or belt skim of a tire cannot be tested for crack growth as the wedge is typically 0.030 inch to 0.045 inch thick and the skim is 0.20 inch to 0.035 inch thick. Fatigue crack testing of the actual belt wedge and/or belt skim (or any other thin portion of the tire), would also enable an aged tire to be tested to determine how the aging process affects a particular compound's crack growth resistance.

It would therefore be an advantage to provide a fatigue crack test method utilizing smaller test specimens and to develop a test method to test actual portions of a tire both in the new condition and after aging of the tire. It would also be an advantage to develop a test method to predict the relative crack growth failure life of a compound throughout the life of a tire.

### SUMMARY OF THE INVENTION

In general, one aspect of the invention is to provide a method of determining the crack growth life of a thin, polymeric material. The method includes the steps of providing a sample of the thin, polymeric material having a predetermined length, width and thickness, wherein the samples have a thickness from about 0.020 inch to about 0.030 inch, forming a groove in the sample, forming a crack in the groove, securing the sample in a test apparatus, cycling the sample in a bending mode at a predetermined frequency in the test apparatus, and measuring a crack length in the sample after a predetermined number of cycles.

Another aspect of the invention is to provide a method of preparing a groove in a thin, polymeric material for determining the crack growth life. The method includes the steps of providing a sample of the thin, polymeric material having a predetermined length, width and thickness, folding over and positioning the sample in a holding device, wherein a predetermined amount of a folded portion of the sample protrudes from the holding device to form a protruding end, excising the protruding end, and removing the sample from the holding device.

In yet another aspect of the invention is to provide a method of preparing a pre-crack in a thin, polymeric material for determining the crack growth life. The method includes the steps of providing a groove in the sample of the thin, polymeric material having a predetermined length, width and thickness, securing the sample in a holding device, piercing a portion of the groove of the sample with a piercing instrument to form the pre-crack having a width from about 0.005 inch to about 0.010 inch, wherein the piercing instrument is a hypodermic needle, and removing the sample from the holding device.

The test results provided utilizing a method of the invention may then be utilized to predict the crack growth failure life for a particular compound by using samples at different stages of aging. The test results provided utilizing the method disclosed will also provide a quantitative measure of the fatigue crack growth which may lead to a rationale for product separation failure.

### BRIEF DESCRIPTION OF THE DRAWINGS

FIG. 1 is a plan view and a side view of the test specimen in accordance with the present invention with a chart showing actual dimensions;

FIG. 2 is a cross-sectional view of the grooving jig with the test specimen protruding from the jig;

FIG. 3 is a perspective view of the test specimen after the groove has been cut;

FIG. 4 is a plan view of the test specimen with a puncture perpendicular to the length of the specimen and a close up perspective view of the groove cut into the specimen and the puncture at the bottom of the groove;

FIG. 5 shows a magnified view of the groove cut into an actual specimen;

FIG. 6 is a perspective view showing the size comparison of the specimens of the present invention and the specimens of the DeMattia test method;

FIG. 7 is a perspective view of the test apparatus of the present invention;

FIG. 8 is a frontal view of the clamping mechanism of the test apparatus of FIG. 7;

FIG. 9 is a frontal view of the CCD camera of the test apparatus of FIG. 7;

FIG. 10 is a plan view of the elongated tip of the puncture needle used in the method of the present invention;

FIG. 11 is a side view of the elongated tip of the puncture needle of FIG. 10 rotated 90 degrees to show the point;

FIG. 12 is a plot of crack growth rate versus cycles showing the rate of change in forecasting aging in a new tire; and

FIG. 13 is a plot of the crack growth rate versus cycles for a new product and at various stages during the life of the product.

### DETAILED DESCRIPTION OF THE DRAWINGS

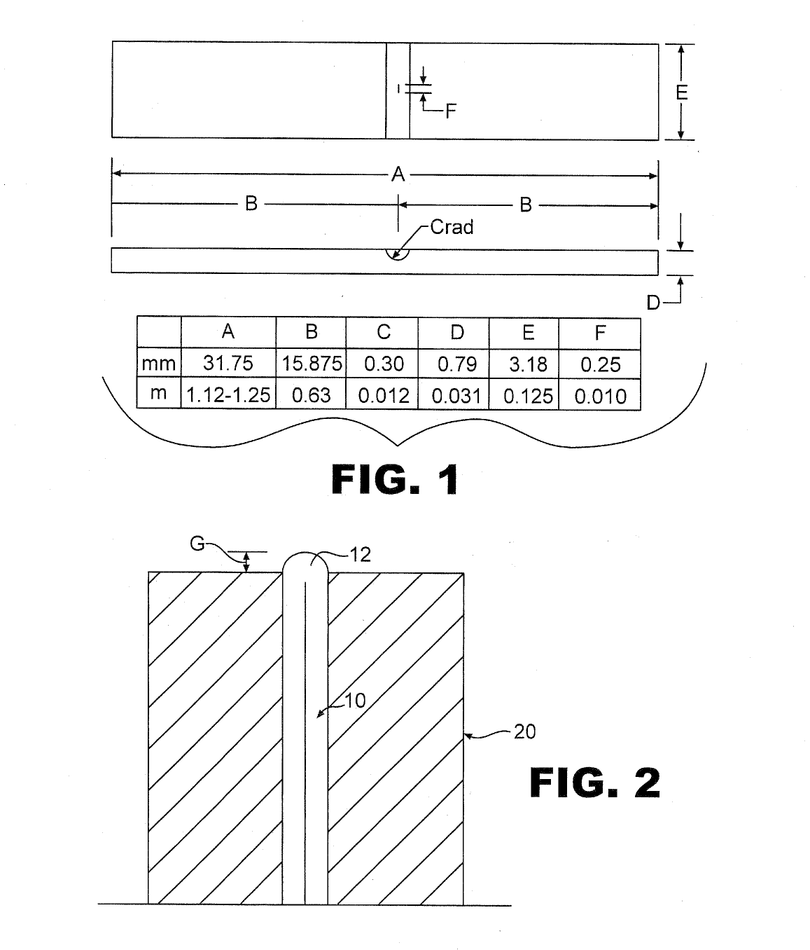

Referring now to FIG. 1, a test specimen 10 in accordance with a first embodiment of the present invention is shown in a plan view and a side view having a length A, a mid-length B, a groove or neck radius C, a thickness D, a width E, and a piercing width F. The actual values of these dimensions of the specimen 10 are shown at the bottom of FIG. 1 in both metric and English units. Based on the values of the dimensions of the test specimen 10, it is evident that the specimen 10 may be taken from most products where a small amount of material is available for testing, such as from the wedge stock or skim stock between the two belts of a tire.

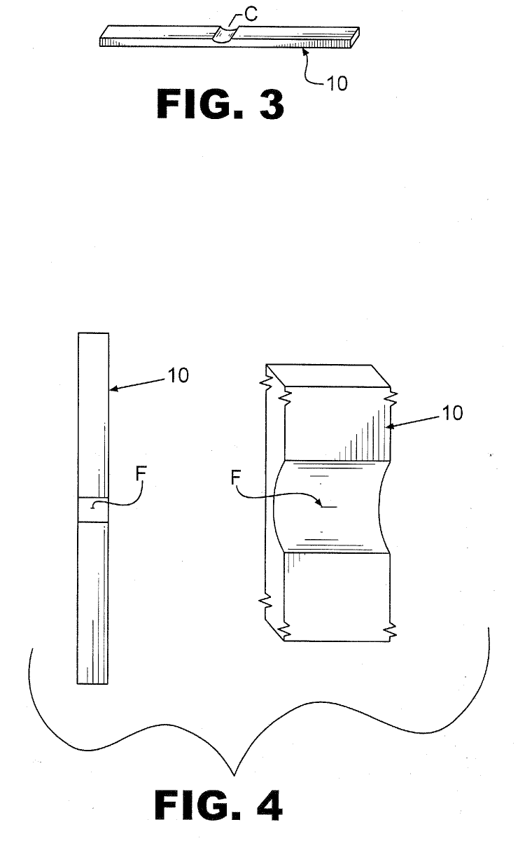

The test specimens 10 are initially cut to the proper length A, width E, and thickness D. Test specimen 10 is prepared by first removing a portion from the products such that a substantially uniform thickness, as an example, ranging from about 0.020 inch to about 0.060 inch is achieved. In another example, the products are prepared having a substantially uniform thickness ranging from about 0.020 inch to about 0.030 inch. Next, specimen 10 is died-out into strips measuring from about 1.5 inches by about 0.125 inch. In order to cut the groove C, a grooving jig 20 may be used as shown in FIG. 2. The specimen 10 is folded over and positioned in the jig 20 with the folded over end 12 of the specimen 10 protruding from the jig 20 by an amount G. The protruding end 12 is then shaved or excised off the end of the jig 20 with a cutting instrument, such as a razor blade, or by first cooling the jig 20 and specimen 10 with dry ice or liquid nitrogen for approximately 30 minutes and cutting the material with a microtome, micro ball end mill or other appropriate cutting instrument (not shown) resulting in an accurately cut groove radius C when the specimen is removed from the jig 20 as shown in FIG. 3. The radius of the groove C may be adjusted by varying the height G of the specimen 10 protruding from the jig 20 and varying the radius of the 180 degree bend. While the specimen 10 could be molded with the groove C, it is anticipated that more consistent results are obtained with a cut groove C due in part to the size of the specimen 10. Molding the specimen 10 would also prevent the actual tire materials to be used in the specimen 10.

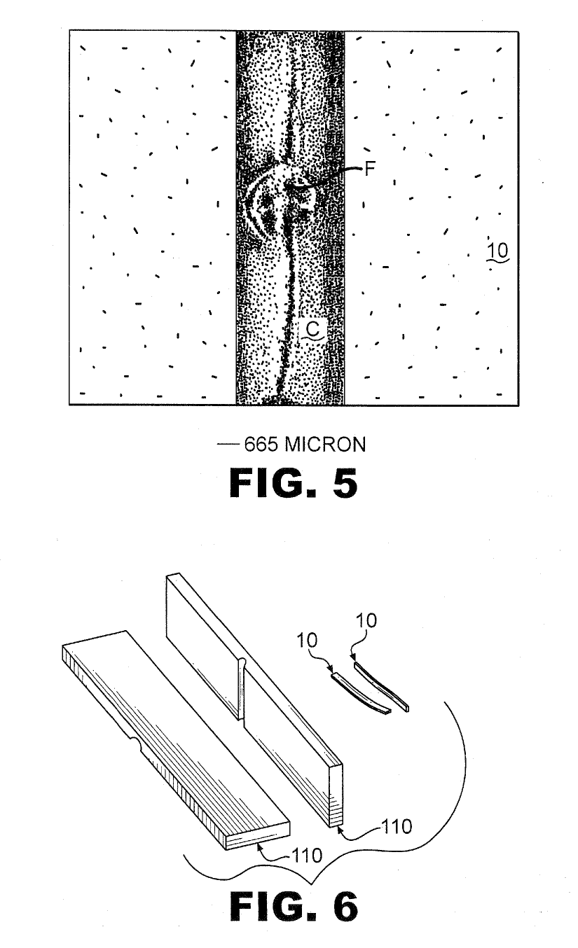

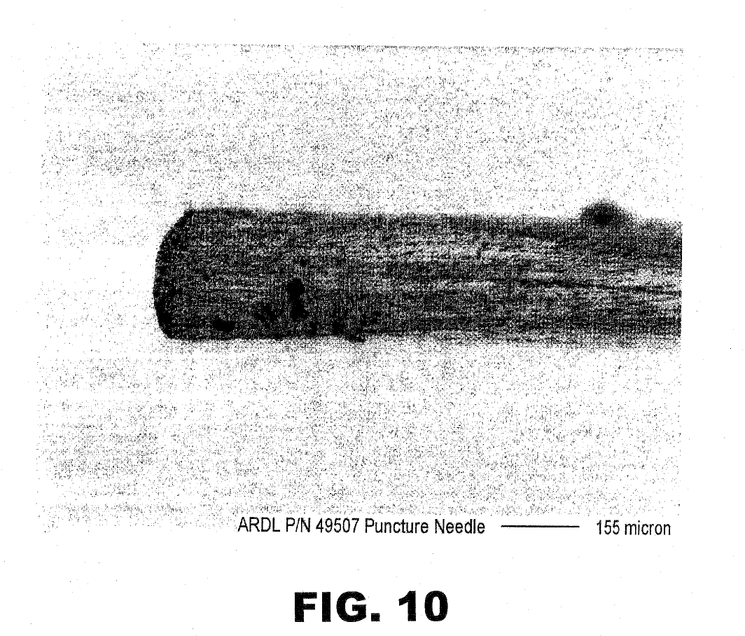

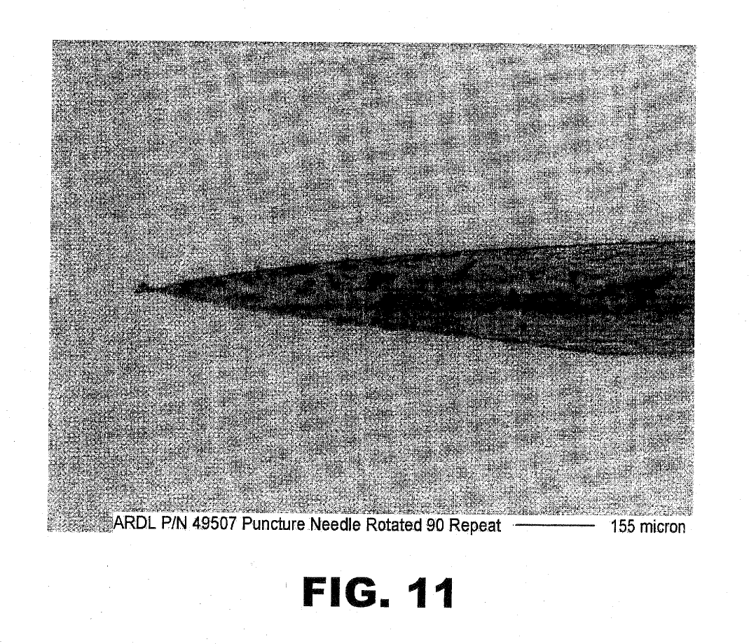

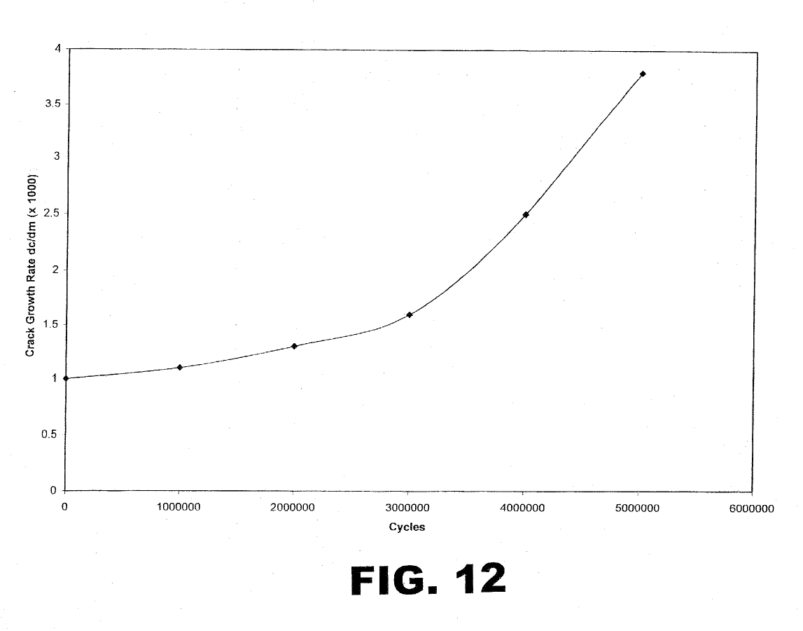

Once the groove C is cut into the specimen 10, the crack or puncture F (both the puncture and puncture length are designated by F) may then be formed at the bottom 14 of the groove C as shown in FIGS. 4 and 5. The specimen 10 is placed into a holding fixture (not shown). A puncture F is put into the center of the groove C perpendicular to the length A of the specimen 10 to create a pre-crack having a width of about 0.005 to about 0.010 inch. The piercing tool may be a spear-type instrument, such as a #33 hypodermic needle 60 which has been flattened and shaped as best shown in FIGS. 10 and 11, or other suitable piercing instrument. It is imperative that the tool is sharp and maintained to the correct dimensions, or test results will be affected.

For comparison purposes, referring now to FIG. 6, the specimens 10 are shown in a perspective view next to ruler and test specimens 110 from a DeMattia test. In a first embodiment of the invention it is anticipated that the specimens should be at a scale size of about ⅛ out 1/12 of the DeMattia test specimens 110.

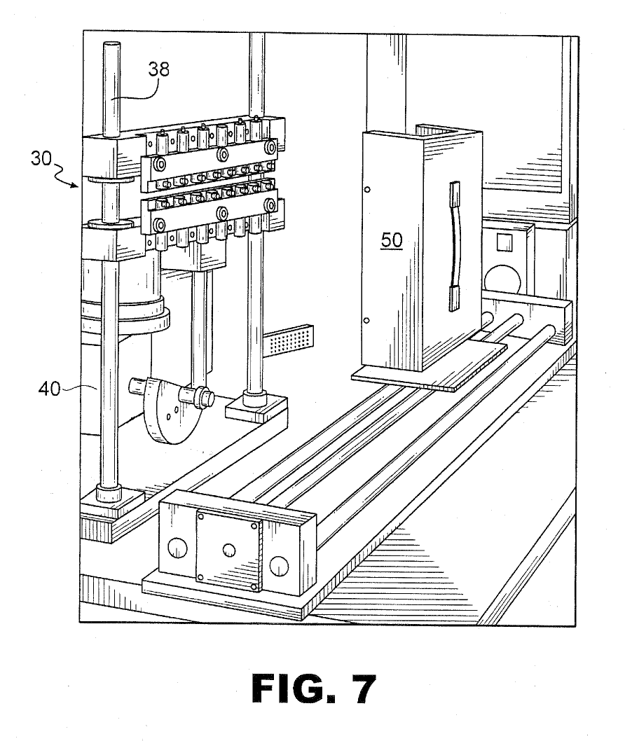

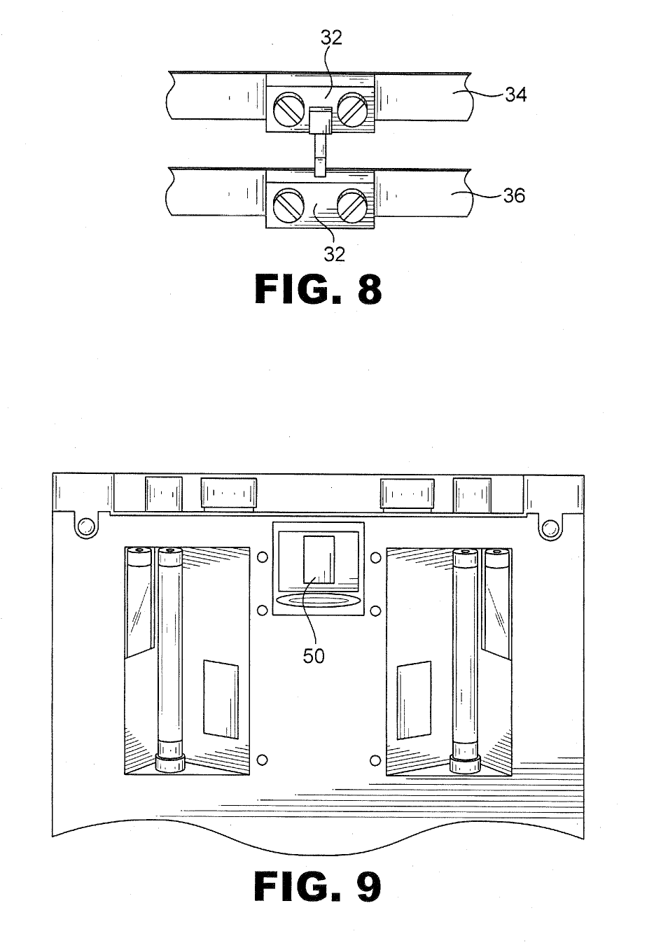

Once the specimens 10 are properly prepared, the specimens 10 are placed in a test apparatus 30 or test machine as shown in FIGS. 7 and 8 which is essentially a miniature sample DeMattia machine. The test apparatus comprises two clamping mechanisms 32 to secure each specimen 10, one on an adjustable stationary member 34 and the other on a similar reciprocating member 36. The reciprocating member 36 is mounted so that its motion is parallel to the direction of and in the same plane as the centerline between the clamping mechanisms 32. The path of travel of the moving member 36 is adjustable and is obtained by means of a connecting rod 38. The moving member is driven by a motor 40 operating at a constant speed. The test apparatus 30 may be designed so that all the specimens 10 are mounted on a single bar 36 and all are flexed at the same time and to the same strain which will provide greater confidence in comparative test results of the specimens 10.

The test apparatus 30 may further comprise a recording device. One example of such a recording device is a linearly moveable charge-coupled device (CCD) camera 50 as shown in FIG. 9. Other optical recording devices known to those skilled in the art are also contemplated. The camera 50 moves along a positioning track 52 and records crack growth at specified cycle intervals as the test occurs. Images are acquired from the camera 50 using a frame grabber. After an image is acquired, imaging analysis software is used to find and measure the size of the crack in each sample. This information is recorded in a data file.

Test Operation—once the specimens 10 are placed in the mounting apparatus 32 and secured in the test apparatus 30. The outer sides are removed after clamping specimens 10 in the center. Then the bracket is inserted in the apparatus 30 at its widest position of stroke. The ends of the specimens are clamped into the apparatus 30, and then the mounting bracket is removed. This will leave the specimens 10 centered and ready for testing. The long axis of the specimen 10 is parallel to the direction of motion of the apparatus 30.

Parallelism of the grips must be maintained at all times. Machines operating within closures may be subject to conditions resulting in different rates of cracking for different positions in the grips. Correlation between all positions should be determined for each machine using a standard control compound.

After adjustments of the apparatus 30 and specimens 10 have been completed, the machine and timer are started. The samples are cycled in a bending mode at a frequency ranging from about 1 Hz to about 50 Hz. At the end of the period of operation, the number of flexing cycles is calculated by multiplying the observed time in minutes by the machine rate of 5 Hz (300 cpm). This shall also be checked by means of a counter on the machine 30. Since the rate of crack growth is important, frequent readings are taken throughout the test by the CCD camera. The test may be cycled for a relatively short period of time such as four hours or 72,000 cycles to obtain a crack growth rate or, alternatively, the test may be continued until a crack 50% of the specimen width forms, however, continuation until break may be desirable when testing aged specimens or when operating at elevated temperatures.

The crack growth data may be reported in any of the following ways: (1) as the crack growth rate at 72,000 cycles; (2) as the number of cycles required to reach a specified crack length; (3) as the average rate of crack growth over the entire test period; or (4) as the rate of cracking in millimeters or inches per kilocycle during a portion of the test.

As previously stated, one of the advantages of the present invention is to use specimens obtained from both new and aged tires. The present invention will also allow validation of artificially aging processes and/or accelerated aging processes by verifying test data of these tires against field aged tires. The artificially aged and or accelerated aged tires may include fleet or track testing, dynamometer wheel testing, oven-aged or other accelerated aging means and combinations of these aging methods, or tires sectioned and aged by the dynamic tire section aging process and apparatus of co-owned U.S. patent application Ser. No. 10/896,767. For example, a test of specimens taken from a new tire, a three year old tire, and a five year old tire may be tested to form a baseline. Specimens taken from artificially aged tires will then be tested to try to duplicate the crack growth rate obtained from the baseline tests.

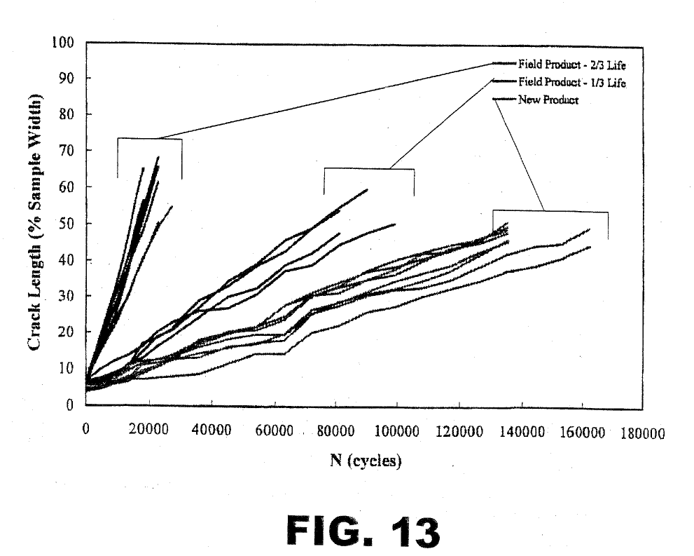

If none of these aging methods coincide with the field data, then other aging methods must be developed. The test method of the present invention could be used in conjunction with other tests as part of the validation process such that the aging method that duplicates the crack growth, physical properties, peel characteristics, crosslink density, and S₈ to S₁ formation of the field-aged tires. As seen in FIG. 13, the plot may be used to assist in the prediction of the service life of the product, for example at one-third of the product life and two-thirds of the product life. This process will allow optimization of the artificial/accelerated aging process by providing a baseline of actual data.

The temperature of the aging method will vary ±5° C. based on geographical location of the field tires. As the tire ages, strain increases (slightly), tearing energy decrease (slightly), tan delta increases, therefore, hysteresis increases (slightly). Testing specimens from field or track aged tires with various amounts of mileage, which has been converted into cycles as seen in FIG. 12, gives us a meaningful prediction of the tire life, which takes into account the fact that the energy to crack or strain energy density to cause crack growth, is the major variable in the equation.

The data is more meaningful if it is taken from a short, but accurate, crack growth rate as in the method of the present invention. This reduces test time considerably and allows the change in crack growth rate to be caused from service in field or accelerated aging conditions and not from the conditions brought about by the flexing of the test apparatus 30 of the present invention.

Another method of examining the fatigue behavior of polymeric products under laboratory controlled, cyclic loading conditions may be achieved by Finite Element Analysis (FEA). Product separation may be due to high service strain and anisotropy of the critical area of the product. FEA of the critical area is conducted using the material properties from modified DeMattia tester described herein, as well as geometrical variations of the product. The local stress (strain) field of the specimen was examined using FEA.

Any service life prediction includes both flaw size and material property changes. The methodology for such a prediction includes measurements as new, 20% life, 40% life, and up to approximately 80% life; measuring the fatigue crack growth behavior using the modified DeMattia instrument and determining the rate of change of fatigue crack propagation cycling time; and developing FEA models to predict stresses in critical regions of the product. In this case, it is realized that the stochastic nature of the product will be difficult to evaluate. Therefore, it is recommended that FEA be used to assess these effects.

When the cyclic stress is below a threshold level (i.e. fatigue endurance limit), the product may have a semi-infinite fatigue life. Above this endurance limit, the S-N curve of cord-reinforced rubber composite follows a power-law rule, as seen in Equation #1:
Δσ=A·(N_{f})^{B} (1)
where Δσ is the stress range in MPa, N_{f} is the fatigue life in cycle and A and B are material constants.

A miniaturized DeMattia test is disclosed, which utilizes a miniature specimen prepared by extracting samples from small pieces of rubber as thin as 0.020 inch from new or aged or used rubber or composite rubber or polymers, such as tires or belts or any polymeric product. The method of producing the specimen includes producing an accurate miniature groove by folding the sample and placing it in a jig, which allows the exact amount of material to be exposed so that when the exposed portion is cut or cleaved, a groove of the desired dimension results; and producing an accurate miniature of the desired initial crack width of about 0.005 inch to about 0.010 inch, depending on specimen thickness, by puncturing the center of the groove, perpendicular to the length of the specimen.

It is further anticipated that the scope of the invention includes obtaining the data from the miniaturized DeMattia crack growth test of materials from the same model or the design of a product, but from various stages of aging, and comparing the results to show how the effect of aging affects the variation in the rate of deterioration of the age-resistant properties of the product, thereby allowing the forecasting of the ability for the material to resist aging as it ages. As an example, as seen in FIG. 12, if a material from a new tire ages at the rate of 0.0010 mm/hr. when new, 0.0011 after 1,000,000 cycles; 0.0013 after 2,000,000; 0.0016 at 3,000,000; 0.0025 after 4,000,000, and fails by 5,000,000, the plot shows the rate of change in forecasting aging.

Although the present invention has been described above in detail, the same is by way of illustration and example only and is not to be taken as a limitation on the present invention.

What is claimed is:

1. A method of determining the crack growth life of a thin, polymeric material, the method comprising the steps of:
providing at least one sample of the thin, polymeric material having a predetermined length, width and thickness, wherein the sample has a thickness from about 0.020 inch to about 0.060 inch;
forming a groove in the sample;
forming a crack in the groove;
securing the sample in a test apparatus;
cycling the sample in a bending mode at a predetermined frequency in the test apparatus; and
measuring a crack length in the sample after a predetermined number of cycles.

2. The method of claim 1 further comprising the step of collecting crack growth data over a period of cycles to determine the crack growth life in the sample of the thin, polymeric material.

3. The method of claim 1, wherein the sample has a thickness from about 0.020 inch to about 0.030 inch.

4. The method of claim 1, wherein at least two clamping mechanisms are used to secure the sample in the test apparatus.

5. The method of claim 4, wherein a first clamping mechanism is connected to an adjustable stationary member and a second clamping mechanism is connected to a reciprocating member.

6. The method of claim 5, wherein a path of travel of the reciprocating member is adjustable.

7. The method of claim 5, wherein the reciprocating member is driven by a motor.

8. The method of claim 1, wherein the polymeric material is a wedge material extracted from new or aged tires.

9. The method of claim 1, wherein the polymeric material is a skim material extracted from new or aged tires.

10. The method of claim 1, wherein the crack has a width from about 0.005 inch to about 0.010 inch.

11. The method of claim 1, wherein the sample is from about 1.0 inch to about 2.0 inch in length and from about 0.100 inch to about 0.200 inch in width.

12. The method of claim 1, wherein the test apparatus further comprises a camera for recording images of crack growth at specified cycle intervals.

13. The method of claim 11, wherein the recorded images are analyzed with imaging analysis software to find and measure the size of the crack in the sample.

14. A method of preparing a groove in a thin, polymeric material for determining the crack growth life, the method comprising the steps of:
providing a sample of the thin, polymeric material having a predetermined length, width and thickness;
folding over and positioning the sample in a holding device, wherein a predetermined amount of a folded portion of the sample protrudes from the holding device to form a protruding end;
excising the protruding end; and
removing the sample from the holding device.

15. The method of claim 14, further comprising the steps of cooling the holding device and the sample prior to excising the protruding end.

16. The method of claim 15, wherein the holding device and the sample are cooled with dry ice and/or liquid nitrogen.

17. The method of claim 14, wherein the protruding end is excised with a cutting instrument.

18. The method of claim 17, wherein the cutting instrument is selected from the group consisting of a razor blade, a microtome, and a micro ball end mill.

19. The method of claim 14, wherein the holding device is a jig.

20. A method of preparing a pre-crack in a thin, polymeric material for determining the crack growth life, the method comprising the steps of:
providing a groove in the sample of the thin, polymeric material having a predetermined length, width and thickness;
securing the sample in a holding device;
piercing a portion of the groove of the sample with a piercing instrument to form the pre-crack having a width from about 0.005 inch to about 0.010 inch, wherein the piercing instrument is a hypodermic needle; and
removing the sample from the holding device.
